(19) United States
(12) Patent Application Publication
(10) Pub. No.: US 2006/0203820 A1
(43) Pub. Date: Sep. 14, 2006

(54) Method and system for communicating and isolating packetized data through a plurality of last-mile carriers to form a multi-node intranet

(76) Inventor: Marc Coluccio, Seattle, WA (US)

Correspondence Address: DLA PIPER RUDNICK GRAY CARY US, LLP, 2000 UNIVERSITY AVENUE, E. PALO ALTO, CA, 94303-2248, US

(21) Appl. No.: 11/035,206

(22) Filed: Jan. 13, 2005

Related U.S. Application Data
(60) Provisional application No. 60/537,268, filed on Jan. 16, 2004.

(51) Int. Cl. H04L 12/56

(52) U.S. Cl. 370/392

(57) ABSTRACT

The invention provides a system and method for transporting packetized data between remote geographic locations in a multi facilities-based carrier and multi-last mile access environment to form a multi-node intranet. The purpose of the invention is to implement a secure, private data service using disparate facilities-based carriers for last-mile connectivity to achieve cost reduction compared to single-carrier, private line or switched or routed private solutions. This is done by providing a system for increased data latency predictability, increased average data latency reduction, and end-to-end data prioritization compared to virtual private networking services utilizing tunneling protocols or public infrastructures for data switching or routing.

### RELATED APPLICATIONS/PRIORITY CLAIM

This application claims priority under 35 USC 119(e) and is a continuation in part of U.S. Provisional Patent Application Ser. No. 60/537,268 filed on Jan. 16, 2004 and entitled “Method and System for Communicating and Isolating Packetized Data through a Plurality of Last-mile Carriers to Form a Multi-node Intranet” which is incorporated herein by reference.

### FIELD OF THE INVENTION

This invention relates generally to a system and method of communicating packetized data between geographically remote locations through a plurality of facilities-based last-mile access carriers and consequently a plurality of long haul access technologies and through a carrier ingress circuit bank to form a multi-point intranet. The system establishes a new method for implementing a private, switched or routed intranet solution that would normally utilize the Internet, tunneling data encapsulation or both for data transport.

### BACKGROUND OF THE INVENTION

When companies are distributed throughout large domestic and international geographies, there is often a demand for the Local Area Networks (LANs) in those disparate locations (nodes) to connect together to form one network (an intranet) as a logical extension of one another. In such cases, there are two methods possible to accomplish this: 1) private lines and switched solutions and, 2) virtual private networks. However, each of these current solutions have limitations and drawbacks.

Firstly, private lines and switched solutions such as Frame-Relay or ATM (Asynchronous Transfer Mode) may be used for connecting the LANs together, which forms an intranet. In this case, the intranet can be isolated from external networks because the data is not required to pass through a public routed network, which ensures security. If such private lines or a switched solution is used, some problems arise such as the high network cost compared to public routed intranets or VPNs, and the last-mile connectivity options of each node are decreased due to reliance on a single carrier for true isolation from external networks.

The current private line and switched solutions use a Customer Premises Device (CPD) as shown in FIG. 2. The CPD has a packet transfer unit 902 which is provided between a private network interface 901 associated with its own local area network and a carrier network interface 904 through which the CPD transfers data to a carrier network for private routing or switching via a virtual connection to a remote node. The packet transfer unit 902 is associated with a routing table 903 to search for the necessary information for routing a packet to the appropriate destination node based on the destination IP (Internet Protocol) address contained in the packet. A diagram of this process is shown in FIG. 4.

Secondly, along with the rapid spread of the Internet and cost reduction resulting from the use of a plurality of last-mile carriers for connectivity, there has appeared a strong demand for forming Virtual Private Networks (VPNs) through a public routed network (the Internet), thereby allowing the use of a plurality of last-mile carriers for cost reduction and emulating the isolation from external networks through the use of tunneling protocols originating and terminating between VPN devices located at remote nodes. The VPN interconnects a number of local area networks through the Internet for the purpose of transporting IP packets between remote IP nodes identified by uniquely assigned IP addresses.

The current VPN uses the device shown in FIG. 1. This contains a VPN packet transfer unit 802, a tunneling unit 804 and an internet packet transfer unit 806, all of which are provided between a private network interface 801 associated with its own LAN and a public network interface 808 through which the router transfers data to an Internet Service Provider (ISP) and subsequently to the Internet or other known public routed network. Both the packet transfer units 802 and 806 are respectively associated with routing tables 803 and 807 to search for the necessary information for routing a VPN packet to the appropriate destination node based on the destination IP address contained in the packet. The tunneling unit 804 is associated with an address translation table 805 for appending a routable IP header to a VPN packet received from the VPN packet transfer unit 802 to formulate an IP packet for transmission to the Internet via the Internet packet transfer unit 806. When the tunneling unit 804 receives an IP packet from the Internet via the internet packet transfer unit 806, it removes the routable IP header from the packet and forwards the remaining VPN packet to the associated LAN via the VPN packet transfer unit 802. This process adds both physical data overhead to a data packet for routing purposes and processing overhead due to the inspection of every packet. Occasionally the process adds data payload encryption and decryption depending upon the implementation. This process provides no means for different types of data prioritizing or a guaranteed Quality of Service (QoS) across the virtual private network including QoS maintenance throughout the intermediary carrier or Internet routers.

However, a need may exist to have an internet that uses a plurality of last-mile carriers such as in a VPN, but also have the QoS (reduced average latency and jitter) within the system such as within a private line or switched intranet. There may also be a need to allow data prioritization and Class of Service (CoS) maintenance throughout the intranet or to eliminate the need for a VPN router. Since a private line, private switched or routed solution cannot use a plurality of last-mile carriers, a cost reduction through a private line, private switched or routed solution cannot be achieved. Furthermore, since a VPN uses a public routed network for data transport, such as the Internet, QoS parameters are not enforced throughout the intermediate network routers and it becomes impossible to uniquely identify the quality of service for each VPN packet to guarantee its latency and delivery order. This is also the case with CoS where intermediate network routers do not maintain traffic prioritization settings that coincide with the end nodes' VPN Routers or other customer premise devices, so an end-to-end CoS cannot be enforced. Also, the current requirement to maintain configuration for multiple tunnels and optional security keys and certificates within the VPN devices for multi-point virtual private networks may be a configuration and maintenance burden.

As shown in FIG. 3, a VPN may consist of multiple end nodes (LAN101, LAN102, LAN103) each containing a VPN device (VPN Device101, VPN Device102, VPN Device103). Each VPN device is connected through a last mile broadband data circuit that terminates with a layer 2 protocol at an ISP (ISP101) where a layer 3 routable IP address is assigned to the layer 2 PVC. All data traffic originating from the end node LAN that has a destination of a routable IP address will pass through the VPN device with either no interference or NAT (Network Address Translation) to allow successful communication with other routable IP addresses. All traffic originating from the end node LAN that has a destination of a different end node LAN within the VPN Intranet, will pass into the VPN device and the process described above will occur. When the data packets pass to the ISP and onto the Internet backbone, the data is in the Public Routed Network. All routers within the Public Routed Network contain routing tables that allow data to pass to their next-hop peer in order to successfully deliver data with a destination of a public routable IP address to the correct ISP, where the data is passed to the end node layer 2 PVC terminating at the VPN device. Data traveling over the Public Routed Network may pass through a number of HOPS (public routers) before reaching its destination. The maintenance of data prioritization and QoS is not likely throughout this process as the process was not designed to fulfill that need.

Thus, it is desirable to provide a method and system for communicating and isolating packetized data through a plurality of facilities-based carriers that overcomes the limitations with the typical systems described above and it is to this end that the present invention is directed.

### SUMMARY OF THE INVENTION

In accordance with the invention, a method is provided for implementing virtual connections between remote nodes and aggregation POPs (Point of Presence) for the purpose of forming private multi-point intranets through a plurality of last-mile carriers and a carrier ingress circuit bank. Also described is a method for providing centralized Internet access to a multipoint intranet without assigning individual routable IP addresses to any CP device, thus alleviating the need for a CP Device to perform Network Address Translation.

A system comprised of a carrier ingress circuit bank connected to an aggregation device in conjunction with a virtual router device located in a co-located telecommunications facility for the purpose of providing packet switched and routed data connectivity from node to node, may allow connectivity through a plurality of facilities based and last-mile carriers while simultaneously guaranteeing end-to-end QoS and CoS on the intranet and eliminating the need for a VPN device for tunneling and encryption.

According to the present invention, there is a method for building an Aggregation POP comprised minimally of a Carrier Ingress Circuit Bank, Aggregation Device and Virtual Router Device. The Carrier Ingress Circuit Bank consists of a plurality of clear channel and channelized ingress circuits cross-connected to facilities-based carriers. Each circuit will implement a layer 2 protocol, such as Frame-Relay, ATM or MPLS, and connect via a compatible interface to the aggregation device. The aggregation device will terminate all circuits from the Carrier Ingress Circuit Bank and establish Virtual Connections through the respective carrier network to any remote node. The aggregation device will translate the virtual connection into an ATM permanent virtual connection (PVC) and switch said PVC onto the Layer 2 Cross Connect Circuit which is connected to a compatible interface on both the aggregation device and the Virtual Router Device.

The Virtual Router Device will inspect the PVC and lookup a virtual private information/virtual private connection (VPI/VCI) in the Customer Circuit Table. It will then associate the PVC with the appropriate pre-provisioned customer virtual router. The Virtual Router Device will then terminate the PVC on a virtual router interface which is connected to the customer's virtual router with a private IP address 601 and also assign a next hop address to the CP Device. The Virtual Router Device will then establish or append to the Customer Routing Table, a Route using the created remote (next-hop) IP address as the next-hop gateway with the remote node's LAN attached IP subnets as the destination subnets. All other nodes' data will follow the same procedure and the end result will form a layer 2-isolated multipoint intranet through a plurality of facilities-based carriers with increased data latency predictability, average data latency reduction and end-to-end data prioritization when compared to virtual private networks.

When a remote node virtual circuit termination spans two or more Carrier Ingress Circuit Banks and therefore two or more aggregation POPs, PVCs are established between an aggregation device and a virtual router device through an ATM cross-connect where the virtual router device terminates the PVC onto a single customer's virtual router 116 with a private IP address. (See FIG. 5) The aggregation device then switches the PVC through a clear channel or switched Inter-POP transport circuit to an aggregation device. The aggregation device then switches the PVC through an ATM cross-connect to a virtual router device, which terminates the PVC into a virtual router with a private IP address.

Thus, in accordance with the invention, a method for cross-connecting to facilities based carriers with layer 2 based cross-connect circuits in order to form a Carrier Circuit Bank is provided. First, physical cross-connect circuits are deployed from multiple qualified local exchange carriers wherein one side of the cross-connect is terminated into a compatible interface on that carrier's network switching equipment and the other side is terminated into a compatible interface on the aggregation device. Then, a packet-switched protocol over the physical cross-connect is used that uniquely identifies individual remote nodes with unique PVCs or VC_IDs. The multiple physical cross-connects are terminated into an aggregation device that maintains a static or dynamic PVC Association Table.

In accordance with another aspect of the invention, a method of building an intranet through a plurality of last-mile carriers for the purpose of providing data transport between remote nodes so the data never passes through the Public Routed Network is provided wherein traffic prioritization and quality of service (QoS) can be implemented and guaranteed. The method also provides a secure way to transport data between remote nodes. To build the intranet, a carrier-circuit bank and an aggregation point of presence (POP) are built. Then, a connected carrier provisions a PVC or Unique VC-ID between the remote node and the respective carrier ingress circuit. Then, a PVC from the Aggregation Device into the Virtual Router Device is provisioned and a Virtual Router for every Customer is provisioned that terminates PVCs from that Customer's remote nodes. Using this method data packets may be switched and routed.

In accordance with yet another aspect of the invention, a method to provide centralized and shared firewall services and network address translation to a multi-node intranet is provided that further provides Internet access and security services. To accomplish this, a separate Virtual Router is provisioned within the Virtual Router Device. The virtual router may be connected to a Customer Virtual Router via a virtual interface, PVC or physical PVC running through a loopback connection. Then, in-service or out-service network address translation is implemented on all data traffic respectively entering or exiting the interface on the virtual router with a destination outside the Customer intranet.

The system may also provide multiple broadband circuits to a single location through a plurality of last-mile access carriers. The use of a plurality of last-mile access carriers is preferable to using a single carrier due to potential carrier backbone or equipment failures which would affect multiple circuits of that single carrier. By using one or more carriers to each site, the system permits real-time load balancing between the carrier loops, automatic fail-over between carrier loops and as much as 99.999% availability for VoIP, WAN and Internet.

### BRIEF DESCRIPTION OF THE DRAWINGS

FIG. 1 is a block diagram of a prior art VPN device used to establish a virtual private network through a public routed network;

FIG. 2 is a block diagram of a prior art Customer Premises Equipment (CPE) device used to establish a private network through a single facilities-based switched carrier network;

FIG. 3 is a block diagram of a prior art virtual private network implementation using a plurality of last-mile and facilities based carriers and utilizing a public routed network for data transport;

FIG. 4 is a block diagram of a prior art switched private network service implementation using a single carrier to establish a truly isolated multi-point intranet;

FIG. 5A is a block diagram illustrating the communications system in accordance with the invention;

FIG. 5B is a block diagram of a customer premises (CP) Device that is used to implement the system in accordance with the invention;

FIG. 5C is a diagram illustrating further details of the communications system in accordance with the invention;

FIG. 6 is a block diagram of an implementation of the invention illustrating the connecting of three remote nodes through a carrier ingress circuit bank, terminating into the POP location and forming a layer 2-isolated multipoint intranet;

FIG. 7 is a block diagram of an Aggregation point of presence (POP) in accordance with the invention;

FIG. 8 is a block diagram illustrating the data flow through the system in accordance with the invention;

FIG. 9A illustrates more details of a virtual router device with two virtual routers to implement a method for accessing the Internet without assigning a routable IP address to any CP device;

FIG. 9B illustrates a virtual router device with two virtual routers with a loopback interface between the virtual routers;

FIG. 9C illustrates a virtual router that uses a well known network address translation process to eliminate the need for virtual router 126;

FIG. 10A is a diagram a multi-carrier loop diversity and load balancing method in accordance with the invention; and

FIG. 10B is a diagram illustrating an example of an implementation of the load balancing method in FIG. 10A using a remote node, carrier aggregation and aggregation point of presence as shown in FIG. 6.

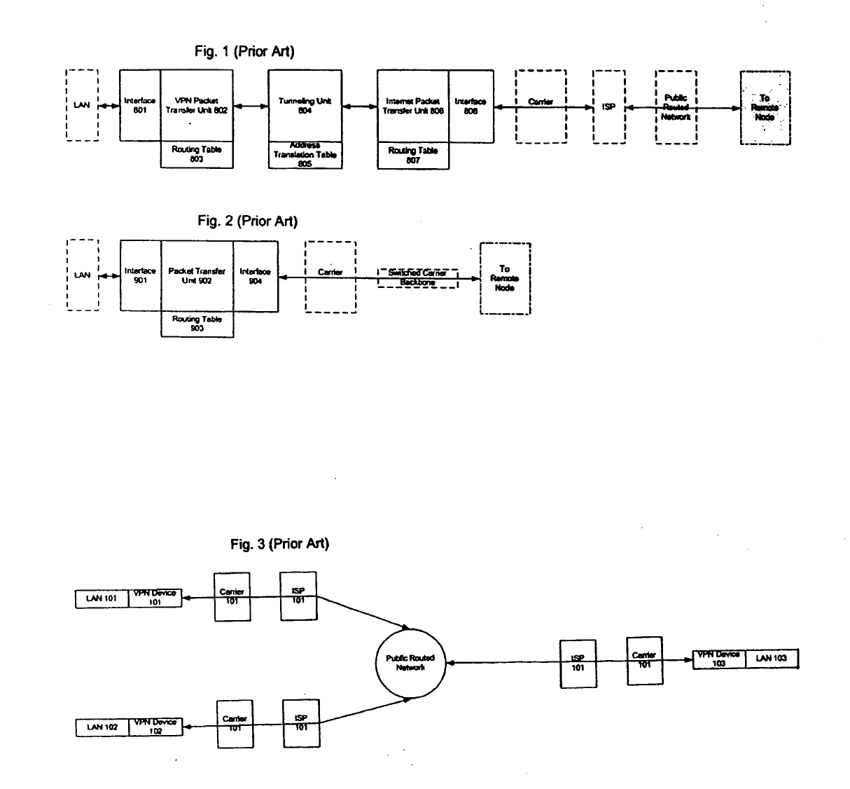

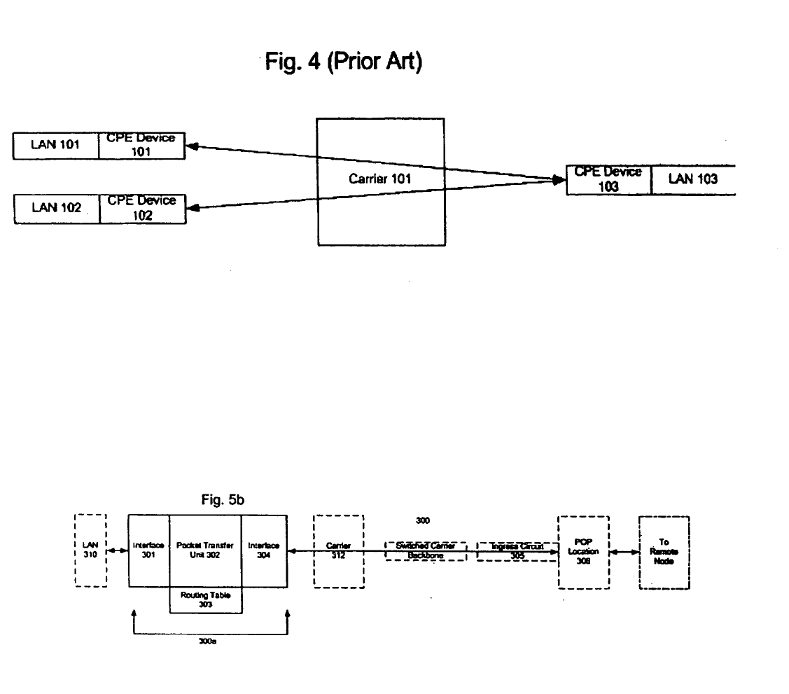

### DETAILED DESCRIPTION OF A PREFERRED EMBODIMENT

The invention is particularly applicable to computer implemented system for communicating and isolating packetized data and it is in this context that the invention will be described. It will be appreciated, however, that the system and method in accordance with the invention has greater utility.

Prior to describing the system and method in accordance with the invention, some description of the terminology that will be utilized below is provided. A node is a physical business or residential location. A carrier network is any facilities-based data or voice carrier with last-mile, local, regional, or national facilities (such as DSL, T1 lines, etc.) that provide layer 2 or layer 3 data communication access between one or more points of presence (POPs) and users. An ingress circuit bank consists of layer 1, layer 2 and layer 3 cross-connect circuits that provide data communication between POPs and the carrier networks. An aggregation unit (Agg. Unit) is a data switching device that physically terminates ingress circuits and translates virtual circuits, in a preferred embodiment, into asynchronous transfer mode (ATM) permanent virtual circuits (PVCs). A Layer 2 cross-connect circuit connects the aggregation unit to the virtual router unit and implements ATM as a switching protocol for traffic separation. A point of presence (POP) location is a physical site located in a collocation facility that houses the aggregation unit and the virtual router unit. An inter-POP transport circuit consists of a leased data line terminating on either end of an aggregation unit that implements ATM as a switching protocol. Now, the system and method in accordance with the invention will be described in more detail.

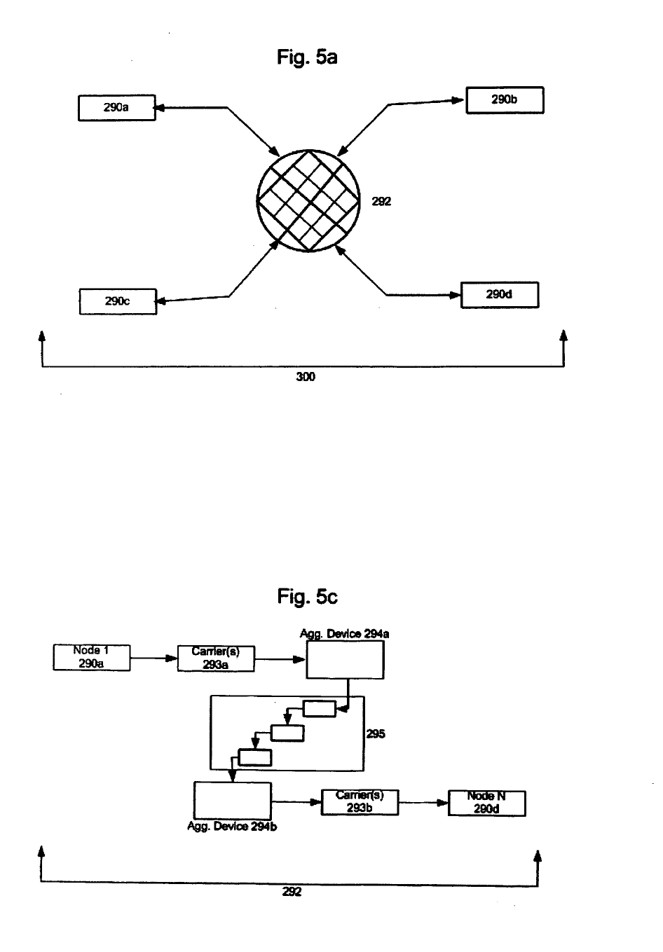

FIG. 5A is a block diagram illustrating the communications system 300 in accordance with the invention wherein one or more nodes, such as nodes 290a-d shown in the example in FIG. 5A, at different locations are able to communicate data packets with each other. The system comprises a network 292 through which data packets between the nodes are communicated. The communications system aggregates national and regional access networks. In particular, the system physically aggregates these access networks at regional co-located facilities (points of presences (POPs)) through the use of the network 292. In accordance with the invention, a customer of the system is able to use various last-mile access mediums, including T1, DSL, Wireless and Dial-Up, while maintaining complete privacy and security without the need for a virtual private network (VPN) system. The communications system also connects all of its POPs through a private backbone while maintaining true privacy and performance. The use of completely private backbone transport eliminates the performance and security issues that are associated with public and semi-public infrastructures including the Internet. The network 292 allows low-cost end-user equipment that requires little configuration to be utilized and gives the customers the ability to centrally manage all aspects of their network. The system permits policy and routing control and full diagnostics and statistical information that can be accessed from any specified networked location. The system also provides a guaranteed quality of service across multi-vendor networks. Now, the system 300 will be described in more detail.

FIG. 5B is a block diagram of the communications system 300 in accordance with the invention that includes a customer premises (CP) device 300a in accordance with the invention. The CPE 300a connects a local area network (LAN) 310 to a carrier 312 (such as a DSL line, T1 line, cable modem line, etc.) and through a switched or MPLS carrier network to an ingress circuit 305 to a point of presence (POP) location 306 and then onto a remove node. The CPE 300a comprises an interface 301 that interfaces with the LAN 310 and an interface 304 that interfaces with the carrier 312 as shown. The CPE 300a further comprises a packet transfer unit 302 that uses an associated routing table 303 to route the data packets from the LAN 310 through the system 300 to the remote node. Now, the system in accordance with the invention will be described in more detail with reference to FIGS. 5C-8.

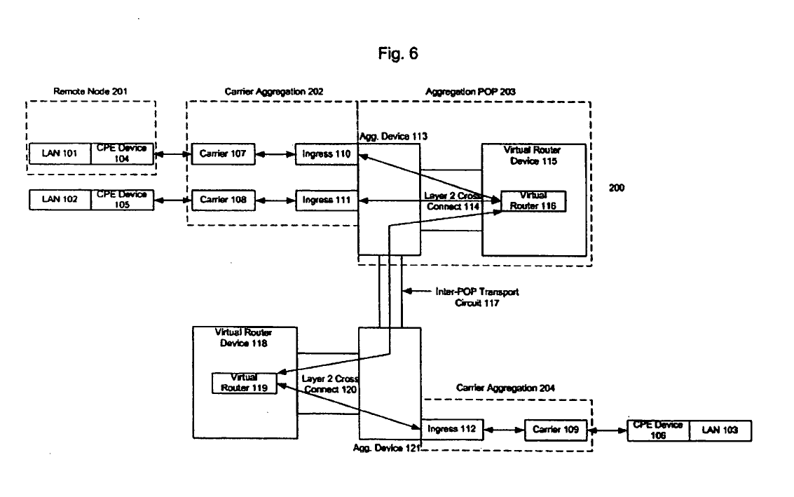

FIG. 5C is a diagram illustrating further details of the communications system 300 and the network 292 in accordance with the invention. In this example, a node 290a (art of which is the CPE 300a in FIG. 5B) is communicating data packets with another node 290d and the network 292 elements required for that communications are shown. The invention is not limited to any particular number of nodes or aggregation devices so that the system 300 may have a plurality of geographically distributed aggregation devices 294. The network comprises one or more carrier(s), such as the carriers 293a, 293b shown in this example, one or more aggregation devices, such as a first aggregation device 294a and a second aggregation device 294b shown in the example in FIG. 5C, and a communications network 295. The carriers 293a, 293b may be various known last mile carriers using various known access technologies, such as a T1 line, a wireless connection or a DSL line that connect the nodes 290a, 290d to the system. Thus, data packets from a node 290a travel over the known carrier 293a to the first aggregation device 294a that converts the data packet into a virtual channel circuit (as described below in more detail) that is then communicated over the communications network 295, such as an ATM network, to the second aggregation device 294b that receives the data packet and converts it back into a VPN packet that is then sent over the carriers 293b to the remote node 290d. In this manner, last mile carriers may be utilized while maintaining privacy and a QoS of the data. In the network 292 shown in FIG. 5C, the nodes (LANs) and the carriers are well known and the system permits the user to utilize various different types of carriers (and last mile carriers). Broadly, the aggregation devices aggregate the various carriers and convert the data packets from the LAN and communicate them over the network 295 to another aggregation device wherein the security and privacy of the data packets are maintained and the QoS for the data packets is maintained. Now, the network, and in particular, the aggregation device, will be described in more detail with reference to FIGS. 6-8.

FIGS. 6 & 7 are block diagrams illustrating an example of an implementation of a system 200 for communicating and isolating packetized data through a plurality of last-mile facilities-based carriers. The diagrams illustrate an isolated intranet of the present invention as established through a plurality of last-mile and facilities based carriers and connects one or more local area networks (LANs), such as LAN101, LAN102 and LAN103 shown in FIG. 6. Each LAN may be connected to a Customer Premises Equipment (CPE) Device, such as CPE Device 104, CPE Device 105 and CPE Device 106 connected to LANs 101-103, respectively. Together, each LAN and CPE device form a remote node 201. In the example shown in FIG. 6, the remote node 201, that has a plurality of LANs and associated CPE devices, is connected through a plurality of last mile access mediums to one or more carriers (such as carriers 107, 108 and 109 respectively shown in the example. The one or more carriers form part of a Carrier aggregation bank 202 that interfaces with one or more carriers and with an aggregation point of presence (POP) 203 to aggregate the signals from the one or more carriers into the aggregation POP 203.

In more detail, the carrier aggregation bank 202 is comprised of one or more last-mile and facilities based carriers (such as carrier 107 and carrier 108 in the example) that maintain switched or Multi-Protocol Label Switching (MPLS) national and regional backhaul networks connected to wired and wireless last-mile connectivity equipment. These carriers are connected to an aggregation point of presence (POP) 203 and an aggregation device 113 (within the aggregation POP 203) via one or more ingress circuits (such as ingress circuits 110, 111, 112 shown in FIG. 6) that may be CATx, DSx, OCx etc. class circuits and are of either clear channel or channelized designation. The invention is not limited to any particular number of carriers or ingress circuits. The construction and operation of the ingress circuits are well known and will not be described further herein.

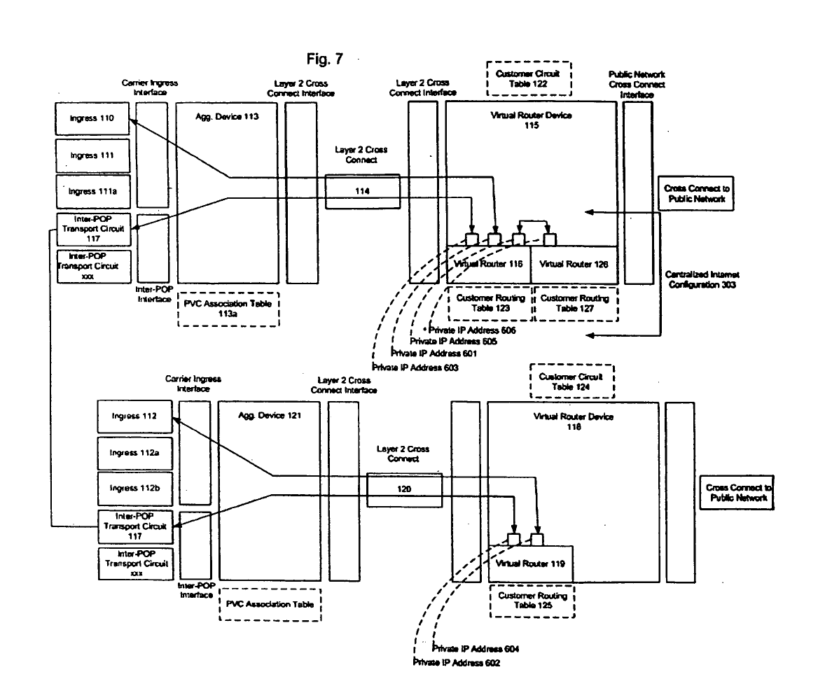

The aggregation POP 203 comprises the aggregation device 113 wherein the aggregation device 113 is cross-connected into a virtual router device 115 via an asynchronous transfer mode (ATM) cross connect 114 which is a clear channel DSx or OCx circuit running the well known ATM protocol. The virtual router device 115 has a pre-provisioned virtual router 116 (a software-based well known virtual router in a preferred embodiment of the invention) for every customer intranet and thus has one or more virtual routers in accordance with the invention (such as virtual routers 116, 126 as shown in FIG. 7). The virtual routers structure and operation are well known and are not described further herein. Thus, the data packets from each carrier (from a particular customer) is passed onto the virtual router device 115 and the particular virtual router 116 for the customer. The Aggregation Device 113 is also cross-connected via a well known inter-POP transport circuit 117 to an interface on other aggregation devices such as a second aggregation device 121. The second aggregation device 121 is cross-connected to both a virtual router device 118 (and to one or more virtual router(s) 119 for each customer) and to a second carrier aggregation bank 204 via one or more ingress circuits (such as ingress circuit 112 shown in FIG. 6). The ingress circuit 112 originates from and is connected to a carrier 109, which is connected to an interface on a CP Device 106, which in turn is connected to LAN 103. The details of each CPE device was described above with reference to FIG. 5B.

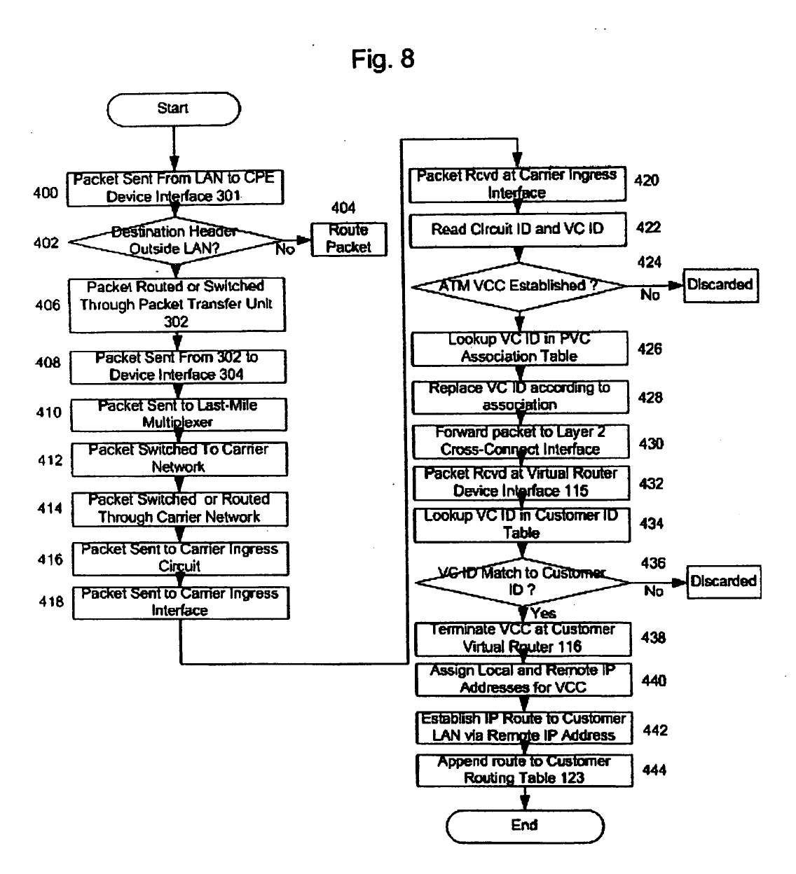

The operation of the system shown in FIG. 6 is described in more detail below with reference to FIG. 8. The system provides packet switched and routed data connectivity from node to node. The system provides connectivity through a plurality of facilities based and last-mile carriers while simultaneously guaranteeing end-to-end QoS and CoS on the intranet and eliminating the need for a VPN device for tunneling and encryption. Now, an example of a remote node virtual circuit termination across two or more carrier ingress circuits and two or more aggregation POPs will be described with reference to FIG. 7.

FIG. 7 illustrates an example of the system 200 wherein an intranet comprised of multiple nodes spans two or more carrier ingress circuit banks and therefore two or more aggregation POPs. In this example, similar elements shown in FIG. 6 have the same reference number and the structure and operation of these similar elements will not be described in detail herein. In this example, one intranet spans across ingress circuits 110, 111, 111a and the other node spans across ingress circuits 112, 112a and 112b as shown. In this example, the intranet may span across one or more carrier ingress circuit banks due to the quantity of data and number of users associated with the intranet. In accordance with the invention, one or more private virtual channels (PVCs) are established between the aggregation device 113 and the virtual router device 115 through the ATM cross-connect 114 where the virtual router device 115 terminates the PVC onto a single customer's virtual router 116 with a private IP address 601. The association of each PVC with each customer may be stored in a PVC association table 113a associated with the aggregation device 113.

The aggregation device then switches the PVC through the clear channel or switched inter-POP transport circuit 117 to the second aggregation device 121 as shown. The aggregation device 121 then switches the PVC through the ATM cross-connect 120 to the virtual router device 118 which terminates the PVC into the virtual router 119 with a private IP address 602. For the PVCs that terminate in the aggregation device 121, the routes to the remote node LAN subnets may be appended to a customer routing table 123 with a next-hop gateway of private IP address 602. Routes to the remote node LAN subnets who's PVCs terminate in aggregation device 113 are appended to Customer routing table 125 with a next-hop gateway of private IP address 603.

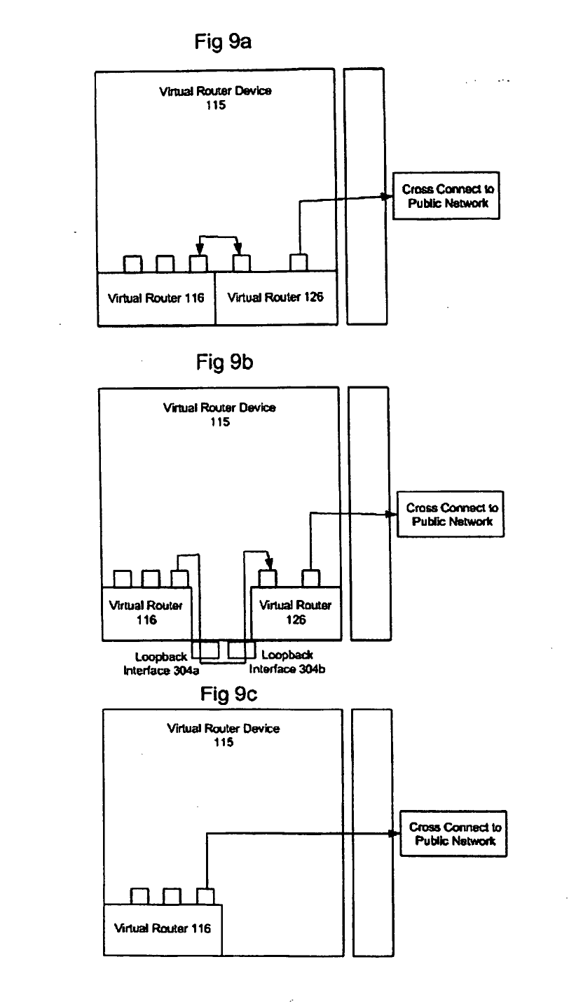

In order for the entire intranet to access the Internet without assigning a routable IP address to any CP Device, two methods are provided. In a first method 303a, another virtual router 126 is provisioned in the virtual router device 115 as shown in FIG. 7 and in more detail in FIG. 9A. To permit access to the Internet, a PVC is created and terminated on the virtual router 116 with a private IP address 605 and on the virtual router 126 with a private IP address 606. The PVC between the virtual routers 116, 126 can either be within the virtual router device 15 or enabled through a loopback connection using two physical interfaces on the virtual router device 115 as shown in FIG. 9B. A well known network address translation process using a routable IP address is applied to the interface on virtual router 126 as an in-service or, as shown in FIG. 9C, to the interface on virtual router 116 as an out-service thereby eliminating the need for virtual router 126. A default route is then appended to the customer routing table 123 with the next-hop gateway of the private IP address 606. A default route is also appended to a customer routing table 125 (associated with the virtual router 119) with the next-hop gateway of the private IP address 603. Furthermore, a route for all connected LAN subnets is appended to a customer routing table 127 (associated with the virtual router 126) with a next-hop gateway of the private IP Address 605. Now, the data flow of the system shown in FIGS. 6 and 7 will be described in more detail.

FIG. 8 is a diagram illustrating a data flow through the system shown in FIGS. 6 and 7. The flow of a data packet through the system is described. In step 400, a data packet is sent from the LAN to the CPE device interface 301 associated with the LAN. In step 402, the CPE device determines if the destination header of the data packet (the destination address) is outside of the LAN. If the destination address is not outside of the LAN, then the data packet is routed within the LAN in step 404 and does not pass through the packet transfer unit 302. If the data packet has a destination address that is outside of the LAN, then in step 406, the data packet is routed/switched through the packet transfer unit 302. In step 408, the data packet is forwarded onto the interface 304. In step 410, the data packet is sent over a last-mile multiplexer (not shown in FIG. 6 or 7, but well known) to a particular carrier network. The multiplexer may select a particular carrier from the carrier aggregation bank 202 based on various factors. Then, in step 412, the data packet is switched to the chosen carrier network. In step 414, the data packet is packet switched/routed through the carrier network where it is received, in step 416, at the carrier ingress circuit.

The data packet is then forwarded onto the carrier ingress interface in step 418 and received in step 420. In step 422, the carrier ingress interface reads a circuit identifier and virtual channel identifier of the data packet. In step 424, it is determined if an ATM virtual channel connection (VCC) is established. If no VCC is established, the data packet is discarded. If the VCC is established, then the virtual channel identification is looked up in the permanent virtual circuit (PVC) association table in step 426. In step 428, the virtual channel identification is replaced with the PVC identification in accordance with the association table. In step 430, the data packet with the PVC identification is forwarded onto the cross-connect interface 114. In step 432, the data packet is received at the virtual router device interface 115. Then, the virtual channel identification for the data packet is determined using the customer identification table in step 434. In step 436, it is determined if the virtual channel identification matches the customer identification for the particular virtual router. If the two do not match each other, the packet is discarded. If the two identifications do match, then the virtual channel connection (VCC) is terminated at the customer virtual router 116 in step 438. In step 440, local and remote IP addresses are assigned to the data packet (the VCC) by the virtual router. In step 442, the IP route to the customer LAN is established using the remote IP address. In step 444, the established route is appended to the customer routing table 123. When the data packet is received by the remote node, it follow the reverse data flow so that the data packet eventually is sent to the particular address in the LAN identified by the data packet destination header.

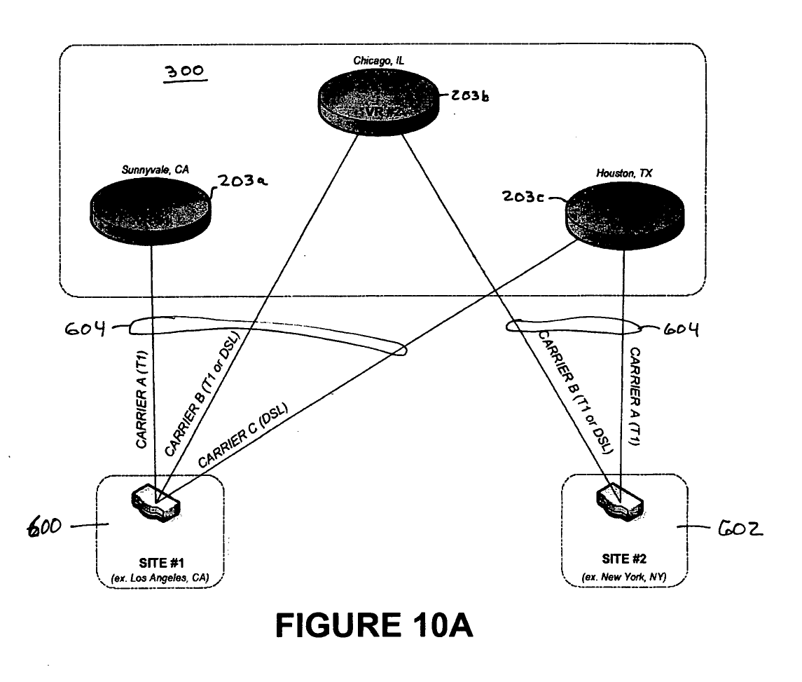

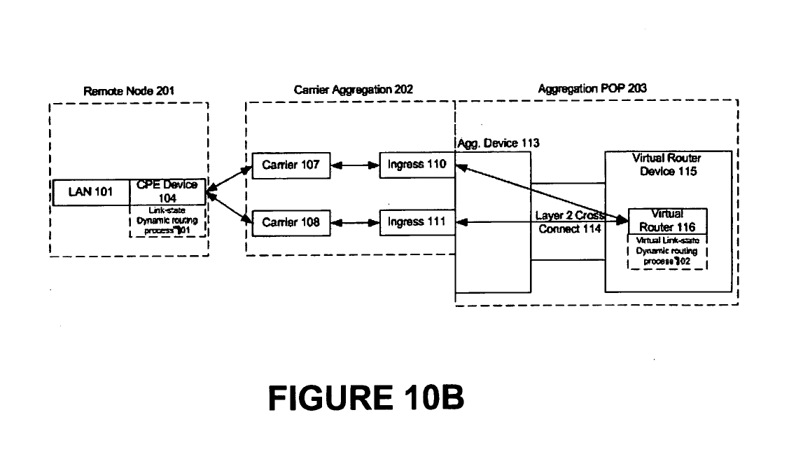

FIG. 10A is a diagram a multi-carrier loop diversity and load balancing method that is implemented in the network 300 in accordance with the invention. Due to the reduction of uptime guarantees of newer broadband access services according to carrier Service Level Agreements and when compared to traditional T1 and ISDN services, it is preferable to be able to provide multiple broadband circuits to a single location through a plurality of last-mile access carriers. Using a plurality of last-mile access carriers is preferable to using a single carrier due to potential carrier backbone or equipment failures which would affect multiple circuits of that single carrier. As shown, the communications network 300 has one or more aggregation points of presence (POP) sites 203a, 203b, 203c (with virtual routers) as shown. A first site 600 and a second site 602 as shown have one or more carrier loops 604 connecting each site to one or more POPs 203a-c. As shown in FIG. 10A, each carrier loop may be of a different type or the same type. In accordance with the invention, the number and types of carrier loops connected to each customer site may be varied. The invention utilizes one or more carriers to each site that permits real-time load balancing between the carrier loops, automatic fail-over between carrier loops and as much as 99.999% availability for VoIP, WAN and Internet. As shown, each carrier loop terminates at an aggregation POP and the aggregation POPs are fully meshed (not shown) to provide continuity in the event of catastrophic failure. The network 300 may use public or private IP addressing at each site. In accordance with the invention, unique, well-known static and dynamic routing tables are maintained for each customer in the network core.

FIG. 10B is a diagram illustrating an example of an implementation of the load balancing method in FIG. 10A using the remote node 201, the carrier aggregation device 202 and the aggregation point of presence (POP) 203 as shown in FIG. 6. The remote node 201 may terminate two or more last-mile broadband circuits 107, 108 (with two or more different carriers) into the CPE device 104. The CPE device 104 may be running a link-state dynamic routing process 701 such as a well known OSPF (Open Shortest Path First) algorithm/method as defined in RFC-1131 by the Internet Engineering Task Force (IETF) http://rtg.jetf.org/. In accordance with the invention, both virtual connections will follow the same data path as described above, going through the aggregation device 113 (in the aggregation POP 203) and terminating in the virtual router device 115. The virtual router 116 may execute a virtualized link-state dynamic routing process 702 which exchanges routing information with link-state dynamic routing process 701. In a preferred embodiment of the invention, the dynamic routing processes may use an Equal Cost Method, non-Equal Cost Method or Auto-Cost method of defining link preference for packet transmission.

At any given point in time, the preferred link (carrier) may be used for packet transmission and this may change dynamically due to dynamic factors including link latency, calculated throughput and link state. For example, if one circuit fails, preference will be given to another link, or if latency spikes on one circuit, preference will be given to another circuit. This method accomplishes greater total throughput compared to a single link, greater uptime likelihood and lower average latency to the virtual router 116. The attributes provided by this method are important for critical data services including Voice over Internet Protocol.

While the foregoing has been with reference to a particular embodiment of the invention, it will be appreciated by those skilled in the art that changes in this embodiment may be made without departing from the principles and spirit of the invention, the scope of which is defined by the appended claims.

1. A method for cross-connecting one or more carriers with a layer 2-based cross-connect circuits in order to form a carrier circuit bank, the method comprising:
cross-connecting one or more local exchange carriers to an aggregation device using physical cross connect circuits, each cross connect circuits connecting an interface of a network of a particular local exchange carrier to the aggregation device;
assigning a virtual circuit identification that uniquely identifies each node that communicates a data packet over the physical cross connect circuits; and
maintaining a physical virtual channel association table in the aggregation device that correlates the virtual circuit identification with each physical cross connect circuits.

2. A method of building an intranet through a plurality of last-mile carriers that provides secure data transport between remote nodes so the data never passes through a public routed network, the method comprising:
providing a carrier circuit bank and an aggregation point of presence (POP);
provisioning one of a private virtual channel (PVC) and a unique virtual channel identification between a remote node of a customer and a respective carrier ingress circuit in the carrier circuit bank;
provisioning a PVC between the aggregation POP and a virtual router device;
provisioning a virtual router in the virtual router device for each customer that will terminate a PVC from the remote nodes of the customer; and
switching and routing data packets from the remote node through the carrier circuit bank and aggregation POP.

3. The method of claim 2, wherein the switching and routing further comprises cross-connecting one or more local exchange carriers to an aggregation device using physical cross connect circuits, each cross connect circuits connecting an interface of a network of a particular local exchange carrier to the aggregation device, assigning a virtual circuit identification that uniquely identifies each node that communicates a data packet over the physical cross connect circuits, and maintaining a physical virtual channel association table in the aggregation device that correlates the virtual circuit identification with each physical cross connect circuits.

4. A method to provide centralized and shared firewall services and network address translation to a multi-node intranet to provide Internet access and security services, the method comprising:
provisioning a virtual router within a virtual router device;
connecting the virtual router to a customer virtual router via a virtual interface, private virtual channel (PVC) or physical PVC running through a loopback connection; and
implementing in-service or out-service network address translation on all data traffic respectively entering or exiting the interface on the virtual router with a destination outside the Customer intranet.

5. A carrier circuit bank, comprising:
an aggregation device;
one or more physical cross connect circuits, each cross connect circuit cross connecting a carrier to the aggregation device to provide an interface between the carrier and the aggregation device; and
a physical virtual channel association table, stored in the aggregation device, that correlates a virtual circuit identification of each node that communicates with a particular physical cross connect circuit with the particular physical cross connect circuits.

6. A method for communicating a data packet from an originating node to a remote node using an address, comprising:
communicating a data packet from an originating node to a carrier;
determining the circuit identification and virtual circuit identification of the data packet;
converting the virtual circuit identification of the data packet into a private virtual channel contained in a private virtual channel association table in an aggregation device;
forward the data packet onto a virtual router device associated with the remote node using the private virtual channel;
comparing, at the remote node virtual route device, the private virtual channel to a customer virtual channel identifier in the data packet;
terminate the virtual channel connection at the remote node virtual router device; and
communicating the data packet to the remote node using a remote IP address based on the virtual channel identifier.

7. The method of claim 6, wherein communicating a data packet from an originating node to a carrier further comprises determining that a destination header of the data packet is outside of the local area network of the originating node, routing the data packet through a packet transfer unit to the carrier.

8. The method of claim 6, wherein forwarding the data packet onto the virtual router device further comprises sending the data packet with the private virtual channel over a network to the virtual router device associated with the remote node.

9. The method of claim 8, wherein sending over a network further comprises sending the data packet over an asynchronous transfer mode network.

10. The method of claim 6, wherein communicating a data packet from an originating node to a carrier further comprises selecting a carrier to carry the data packet from one or more carriers connected to the originating node.

11. The method of claim 10, wherein selecting the carrier further comprises selecting the carrier based on a state of each carrier at the time of the communication of the data packet.

12. The method of claim 11, wherein selecting the carrier further comprises using a dynamic routing process.

13. A communications network, comprising:
an origination node that generates a data packet to be sent over the communications network to a remote note;
one or more carriers, connected between the originating node and an originating aggregation device, that carry the data packet to the originating aggregation device;
the originating aggregation device connected to the one or more carriers that receive the data packet and generate a private virtual connection corresponding to the data packet based on an address in the data packet;
a data network connected to the originating aggregation device that communicates the private virtual connection to a destination aggregation device;
the destination aggregation device, connected to one or more carriers, that receive the virtual private connection and converts it into a data packet that is communicated over the one or more carriers to a destination node.

14. The network of claim 13, wherein the originating aggregation device and the destination aggregation device each further comprise a carrier bank and an aggregation point of presence connected to the carrier bank wherein the carrier bank further comprising one or more physical cross connect circuits, each cross connect circuit cross connecting a carrier to the particular aggregation device to provide an interface between the carrier and the particular aggregation device, and a physical virtual channel association table, stored in the particular aggregation device, that correlates a virtual circuit identification of each node that communicates with a particular physical cross connect circuit with the particular physical cross connect circuits.

15. The network of claim 14, wherein the aggregation point of presence further comprises a virtual router device connected to the carrier bank that receives the data packet from the carrier bank and one or more virtual routers provisioned in the virtual router device with each provisioned virtual router assigned to a particular customer so that each customer has its own provisioned virtual router, wherein the each virtual router receives the data packet from the carrier bank and generates a private virtual channel for the data packet.

16. The network of claim 13, wherein the data network further comprises an asynchronous transfer mode (ATM) network.

17. The network of claim 15, wherein the virtual router device further comprises a special virtual router provisioned in the virtual router device, the special virtual router being used to connect the originating node to the Internet wherein the special virtual router provisions a private virtual channel between the originating node and the Internet.

18. The network of claim 17, wherein the virtual router device further comprises a loopback interface connected between the virtual router assigned to the customer and the special virtual router to route the data packet from the originating node to the Internet.

19. The network of claim 15, wherein the virtual router device further comprises a network address translation unit that is used to connect the originating node to the Internet.

20. The network of claim 13, wherein the originating node further comprises a dynamic routing unit and the originating aggregation device further comprises a virtual dynamic routing unit, the dynamic routing unit and the virtual dynamic routing unit communicating with each other to select a one of the one or more carriers connected to the originating node.

21. The network of claim 20, wherein the dynamic routing unit further comprises an open shortest path first dynamic routing process.

22. The network of claim 21, wherein the virtual dynamic routing unit further comprises one of a equal cost dynamic routing process, a non-equal cost dynamic routing process and an automatic cost dynamic routing process.

23. The network of claim 13, wherein the originating node and the destination node each further comprise a local area network interface that receives a local area network data packet, a packet transfer unit that routes the local area network data packet based on a routing table to generate the data packet.
